(19) United States
(12) Patent Application Publication
(10) Pub. No.: US 2020/0353766 A1
(43) Pub. Date: Nov. 12, 2020

(54) MEDIUM HAVING A COATING LAYER, METHOD OF MANUFACTURING A MEDIUM HAVING A COATING LAYER, AND METHOD OF CHANGING FEEL

(71) Applicant: CASIO COMPUTER CO., LTD., Tokyo (JP)

(72) Inventor: Satoshi MITSUI, Tokyo (JP)

(73) Assignee: CASIO COMPUTER CO., LTD., Tokyo (JP)

(21) Appl. No.: 16/830,824

(22) Filed: Mar. 26, 2020

(30) Foreign Application Priority Data
May 10, 2019 (JP) 2019-089792

(51) Int. Cl. B41M 1/30; B41M 5/26; B32B 5/18; B41M 5/52

(52) U.S. Cl. CPC B41M 1/30; B41M 5/52; B32B 5/18; B41M 5/267

(57) ABSTRACT

A medium includes a base member; and a coating layer that covers at least a portion of the base member, wherein the coating layer includes a binder and thermally distensible particles, and wherein a thickness of the coating layer is smaller than a maximum-distension particle diameter of the thermally distensible particles.

### BACKGROUND OF THE INVENTION

### Technical Field

The present invention relates to a medium having a coating layer containing a thermally distensible material that foams and distends according to an amount of absorbed heat, a method of manufacturing a medium having a coating layer, and a method of changing feel.

### Background Art

The feel of a sheet or the like has conventionally been changed through the provision of recessed/protruding shapes on a surface thereof. Known methods for conferring recessed/protruding shapes include embossing techniques (for example, Japanese Patent Application Laid-Open Publication No. H06-008254).

In another known configuration, resin or the like is injection molded such that recessed/protruding shapes are provided on a surface thereof.

However, one problem with embossing techniques and injection molding techniques is that both require a mold corresponding to such recessed/protruding shapes. Consequently, a way to change feel easily is desired.

The present invention was made in light of the foregoing and aims to provide a medium having a coating layer with which feel can be easily changed, a method of manufacturing a medium having a coating layer, and a method of changing feel.

### SUMMARY OF THE INVENTION

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a medium, including: a base member; and a coating layer that covers at least a portion of the base member, wherein the coating layer includes a binder and thermally distensible particles, and wherein a thickness of the coating layer is smaller than a maximum-distension particle diameter of the thermally distensible particles.

In another aspect, the present disclosure provides a method of manufacturing a medium, including: preparing a base member; and forming a coating layer that includes a binder and a thermally distensible particles on the base member so as to cover at least a portion of the base member, wherein in the forming of the coating layer, a thickness of the coating layer is made smaller than a maximum-distension particle diameter of the thermally distensible particles.

In another aspect, the present disclosure provides a method of changing feel of a medium, including: preparing a medium that includes a base member and a coating layer that covers at least a portion of the base member, the coating layer including a binder and thermally distensible particles, a thickness of the coating layer being smaller than a maximum-distension particle diameter of the thermally distensible particles; and heating a portion of the coating layer to cause distension of the thermally distensible particles in said portion, thereby creating a distended surface profile in said portion of the coating layer so as to cause a feel of touch by a human to differ on said portion of the medium from on other portions of the medium.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a cross-sectional view illustrating an overview of a coated sheet according to an embodiment.

FIG. 2 is a cross-sectional view illustrating a state in which a region of a coated sheet according to an embodiment has been distended.

FIGS. 3A and 3B are cross-sectional views explaining a method of manufacturing a coated sheet according to an embodiment.

FIG. 4 is a flowchart explaining a feel-changing process according to an embodiment.

FIGS. 5A and 5B are cross-sectional views explaining a feel-changing process according to an embodiment.

FIG. 6 is a diagram explaining an overview of a distension device.

FIG. 7 is a cross-sectional view explaining a coated sheet according to another embodiment.

### DETAILED DESCRIPTION OF EMBODIMENTS

A medium having a coating layer, a method of manufacturing a medium having a coating layer, and a method of changing feel according to the present embodiment will described in detail below with reference to the figures.

In the present embodiment, an example is given in which a medium 10 having a coating layer is a sheet (coated sheet 20) having a coating layer.

(Coated Sheet 20)

The coated sheet 20 is provided with a base member 21 and a coating layer 22.

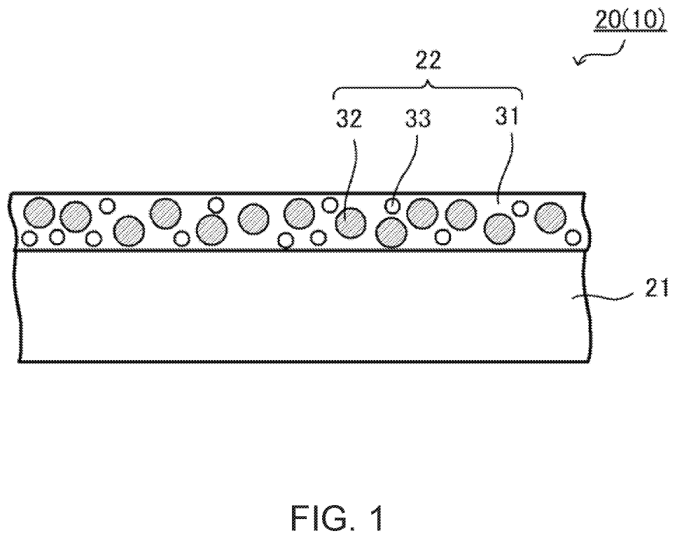

The base member (base element) 21 is a member in the form of a sheet that supports the coating layer 22. The coating layer 22 is formed on one face (a front surface, which is the upper surface in FIG. 1) of the base member 21. Paper such as wood-free paper, or a sheet (this includes film) composed of a resin such as polyethylene terephthalate (PET), is used for the base member 21. Paper used for the base member 21 is not limited to wood-free paper, and another known type of paper can be used therefor. Resin used for the base member 21 is also not limited to PET, and any resin is able to be used therefor. The resin is not particularly limited, and examples thereof include materials selected from, inter alia, polyolefin resins such as polyethylene (PE) and polypropylene (PP), polyethylene terephthalate (PET), polyethylene naphthalate (PEN), polybutylene terephthalate (PBT), polyester resins, polyamide resins such as nylon, polyvinyl chloride (PVC) resins, polystyrene (PS), polyimide resins, and silicone resins. The base member 21 is also not limited to being paper or a sheet made of resin, and may be cloth or the like.

The base member 21 is heat-resistant to a certain extent, and as a result tolerates being heated when the coating layer 22 is foamed. In addition, the base member 21 is endowed with a certain amount of strength such that when the coating layer 22 has been entirely or partially distended by foaming, the side (the lower side in FIG. 1) of the base member 21 opposite thereto does not rise up. The base member 21 is also endowed with a certain amount of strength such that when the coating layer 22 is distended, the sheet-like form of the base member 21 is not negatively affected by, inter alia, creases being produced or by large waves being formed therein. The base member 21 may be elastic, and the base member 21 may deform with distension of the coating layer 22 and maintain this deformed shape after distension of the coating layer 22.

The coating layer 22 is formed on the one face (the upper surface in FIG. 1) of the base member 21. The coating layer 22 is provided so as to coat at least a portion of the one face of the base member 21. The coating layer 22 may be provided so as to cover the entire surface of the base member 21, or may be provided so as to cover a portion thereof. The coating layer 22 contains a binder 31, thermally distensible particles (thermally distensible microcapsules or micropowders) 32, and a feel-adjusting material 33. In the present embodiment, although an example is given in which the coating layer 22 contains a feel-adjusting material 33, it is possible to omit the feel-adjusting material 33 therefrom. The thermally distensible material (particles) 32 and the feel-adjusting material 33 are dispersed within the binder 31 in the coating layer 22. The coating layer 22 is not limited to being composed of a single layer. A plurality of layers containing the thermally distensible material 32 may be provided, and the coating layer 22 configured by stacking these layers together.

Any thermoplastic resin, such as an ethylene-vinyl acetate polymer or an acrylic polymer, may be used for the binder 31 in the coating layer 22. The thermally distensible material 32 is configured by thermoplastic resin shells that contain propane, butane, or other substance that vaporizes at a low boiling point. The shells are, for example, formed from a thermoplastic resin such as polystyrene, polyvinyl chloride, polyvinylidene chloride, polyvinyl acetate, polyacrylic ester, polyacrylonitrile, polybutadiene, or a copolymer thereof. An average particle diameter (d50) of the thermally distensible particles 32 is, for example, 5-50 μm. When the thermally distensible material 32 is heated to or above a temperature at which thermal distension begins, the shells made of resin soften, the substance that vaporizes at a low boiling point contained therein is vaporized, and pressure therefrom causes the shells to distend into balloon shapes. A post-distension particle diameter of the thermally distensible material 32 is about five times a pre-distension particle diameter thereof, though this depends on the properties of the thermally distensible material 32 used. Although particle diameters of the thermally distensible material 32 are illustrated as being roughly the same in FIG. 1, etc., the particle diameters of the thermally distensible material 32 vary, and particles do not all have the same particle diameter.

The feel-adjusting material 33 is a material that adjusts the feel of the coating layer 22. Incorporating the feel-adjusting material 33 into the coating layer 22 makes it possible to, for example, give the front surface of the coating layer 22 a matte feel, a glossy feel, etc. Any material, such as an inorganic material or an organic material, can be used for the feel-adjusting material 33. A porous material such as porous silica or a porous ceramic (for example, porous alumina), or a resin material (for example, beads or the like made of resin) such as polyethylene (PE), polypropylene (PP), or another polyolefin resin, polyethylene terephthalate (PET), a polyester resin, a polyamide resin such as nylon, a polyvinyl chloride (PVC) resin, a polystyrene (PS) resin, a polyvinyl alcohol (PVA) resin, a polyurethane resin, or an acrylic resin, can be used for the feel-adjusting material 33.

A material used in an ink-accepting layer that accepts water-based ink from an inkjet printer and fixes the ink can also be used for the feel-adjusting material 33. If this type of material is used, the coating layer 22 is also endowed with an ability to accept ink according to the amount the feel-adjusting material 33 that is contained within the coating layer 22, which is ideal. The feel-adjusting material 33 may include a porous material such as porous silica or a porous ceramic (for example, porous alumina) with which ink can be accepted making use of voids therein. Such porous materials accept ink by taking up ink into a void therein. The feel-adjusting material 33 may, for example, include a resin selected from, inter alia, polyvinyl alcohol (PVA) resins, polyester resins, polyurethane resins, and acrylic resins. Such resin materials swell with ink, and thereby are able to accept ink.

If a resin material with which the coating layer 22 can be given a glossy feel or the like is used for the feel-adjusting material 33, a difference in feel between a distensible region 22a and a non-distensible region 22b will be more highly emphasized, which is ideal. This is because due to distension of the thermally distensible material 32, the distensible region 22a adopts an uneven surface profile and thus tends to take on a textured feel. Consequently, if the non-distensible region 22b of the coating layer 22 has a glossy feel or the like, it will be easier to distinguish a difference from the distensible region 22a. In addition, if a material that swells with and accepts ink is used for the feel-adjusting material 33, since this material is composed of resin, the coating layer 22 can be given a glossy feel or the like, and the coating layer 22 is endowed with an ability to accept ink according to the amount of the feel-adjusting material 33 contained therein, which is even more ideal.

Although not limited hereto, in the coating layer 22, the thermally distensible material 32 preferably makes up 20-60%, by weight, of the total weight of the binder 31, the thermally distensible material 32, and the feel-adjusting material 33. Further, although not limited hereto, the thermally distensible material 33 preferably makes up at least 10%, by weight, of the overall weight of the binder 31, the thermally distensible material 32, and the feel-adjusting material 33. It is also possible to omit the feel-adjusting material 33 therefrom.

In the present embodiment, an electromagnetic wave/heat conversion layer (hereafter simply referred to as a thermal conversion layer) containing a material that converts electromagnetic waves into heat is formed on at least one face of the coated sheet 20. Irradiating the heat conversion layer with electromagnetic waves causes the heat conversion layer to generate heat. Because the thermal conversion layer heats up when irradiated with electromagnetic waves, this layer is also referred to as a heating layer. Heat produced by a thermal conversion layer provided on the front surface of the coated sheet 20 is transmitted to the coating layer 22, causing the thermally distensible material 32 in the coating layer 22 to foam and distend. The thermal conversion layer converts electromagnetic waves into heat more quickly than in other regions where a thermal conversion layer is not provided. As a result, it is possible to selectively apply heat only to a region in the immediate vicinity of the thermal conversion layer, and to selectively cause only a prescribed region of the coating layer 22 to distend.

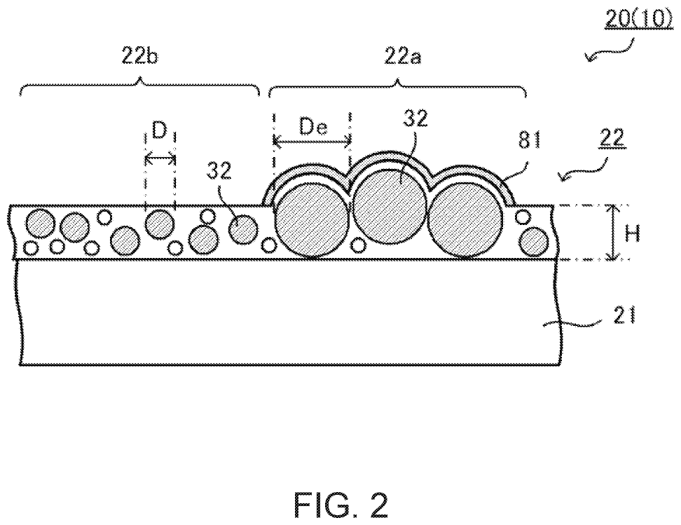

FIG. 2 illustrates a state in which a region of the coating layer 22 has been distended. As illustrated in FIG. 2, in the present embodiment, the thermally distensible material 32 is caused to distend in at least one region of the coating layer 22 (the distensible region 22a illustrated in FIG. 2). The feel of the region where the thermally distensible material 32 has been distended (the distensible region 22a illustrated in FIG. 2) is thereby made to differ from a region where the thermally distensible material 32 has not been distended (the non-distensible region 22b illustrated in FIG. 2).

When distended thermally distensible material 32 projects past the upper surface of an undistended portion of the coating layer 22 (corresponding to the upper surface over the non-distensible region 22b illustrated in FIG. 2), the feel of the distensible region 22a more clearly differs from the feel of the non-distensible region 22b. For this reason, preferably, a thickness H of the coating layer 22 illustrated in FIG. 2 is made thinner than a post-distension particle diameter De of the thermally distensible material 32. The post-distension particle diameter De of the thermally distensible material 32 is, for example, a maximum-distension particle diameter (the maximum particle diameter to which distension is possible).

In cases where, for example, the particle diameter D of the thermally distensible material 32 is 5-50 μm and the particle diameter distends a maximum of five times, preferably, the thickness of the coating layer 22 is formed to be 20-200 μm. To give an example, if the particle diameter D of the thermally distensible material 32 were 10 μm and the particle diameter distends a maximum of five times, the thickness of the coating layer 22 would be set to 30 μm. Note that the particle diameter D of the thermally distensible material 32 is an average particle diameter (for example, a median diameter (d50)).

(Method of Manufacturing a Coated Sheet)

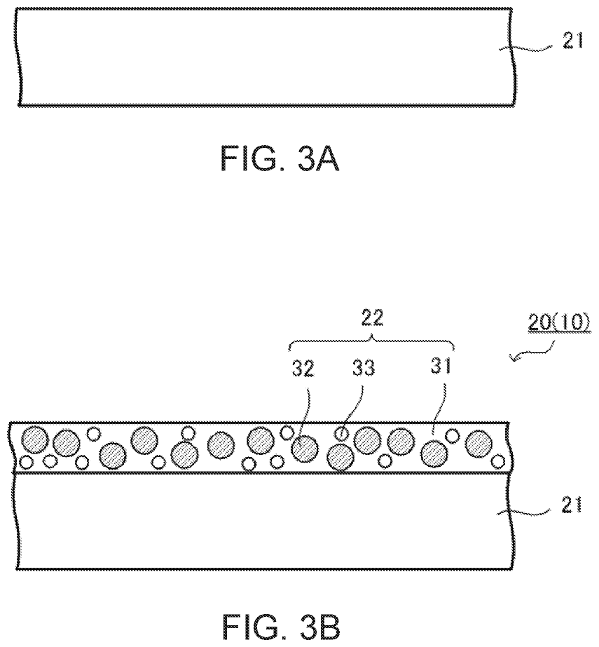

Next, a method of manufacturing a coated sheet 20 will be described with reference to FIGS. 3A and 3B.

First, a base member (base element) 21 is prepared (FIG. 3A). Rolled paper is, for example, used for the base member 21. Note that the following method of manufacture is not limited to rolls, and is also able to be performed on sheets.

Next, a liquid application for forming a coating layer 22 using a known dispersion apparatus or the like is prepared using the binder 31, the thermally distensible material 32, and the feel-adjusting material 33. Note that the feel-adjusting material 33 can be omitted therefrom. Then, the liquid application is applied to one face of the base member 21 using a bar coater, a roller coater, a spray coater, or other known applicator. Then, this coating is dried to form the coating layer 22 as illustrated in FIG. 3B. The liquid application may be applied and dried multiple times in order to achieve a target thickness for the coating layer 22. A printer or the like may also be used to form the coating layer 22.

The thickness of the coating layer 22 is formed thinner than the particle diameter of the thermally distensible material (particles) 32 when distended (post-distension particle diameter De illustrated in FIG. 2).

Then, in cases in which a rolled base member 21 is used, the base member 21 is cut as needed, yielding a coated sheet 20.

Coated sheets 20 are manufactured following the above procedure.

(Method of Changing Feel)

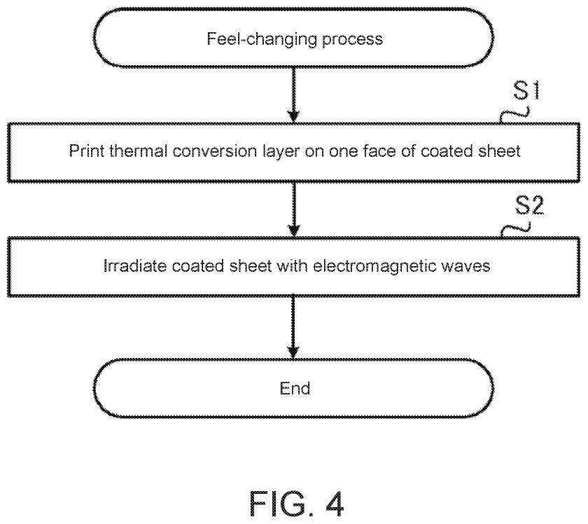

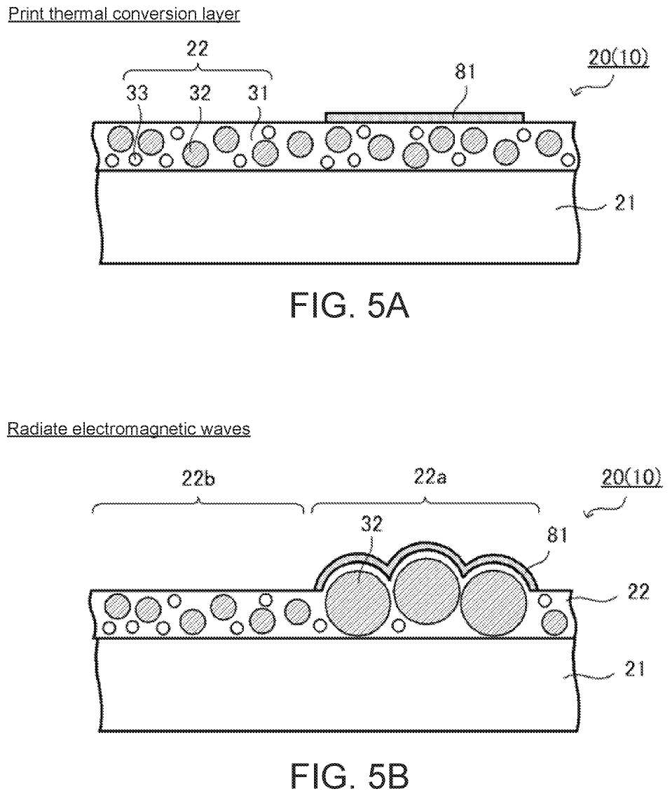

Next, the flow of a process to change the feel of the coating layer 22 of a coated sheet 20 will be described with reference to the flowchart illustrated in FIG. 4 and the cross-sectional view of the coated sheet 20 illustrated in FIGS. 5A and 5B.

First, a coated sheet 20 is prepared. Foaming data (corresponding to a thermal conversion layer 81), which indicates the portion of one face (for example, the front surface) of the coated sheet 20 that is to be foamed and distended, is determined in advance. In a plan view, the thermal conversion layer 81 may take on any shape, such as that of characters, patterns, or graphics. Next, the thermal conversion layer 81 is printed on the front surface of the coated sheet 20 using an inkjet printer, an offset printer, or other known printer (step S1). The thermal conversion layer 81 is a layer formed using foaming ink that contains an electromagnetic wave/heat converting material. The electromagnetic wave/heat converting material, for example, contains, carbon black, cesium tungsten oxide, or LaB₆. The printer prints on the front surface of the coated sheet 20 using the foaming ink in accordance with the foaming data that has been specified. As a result, as illustrated in FIG. 5A, the thermal conversion layer 81 is formed on the front surface of the coated sheet 20. If the thermal conversion layer 81 is densely printed, the amount of heat that will be generated thereby increases, and the thermally distensible material 32 will consequently distend a greater amount. Thus, by controlling the shade of the thermal conversion layer 81, it is possible to control the degree of distension of the thermally distensible material 32.

Secondly, the coated sheet 20 on which a thermal conversion layer 81 has been printed is conveyed into a distension device 50 with the front surface thereof facing upward, and the thermal conversion layer 81 is irradiated with electromagnetic waves, causing the coating layer 22 to distend (step S2).

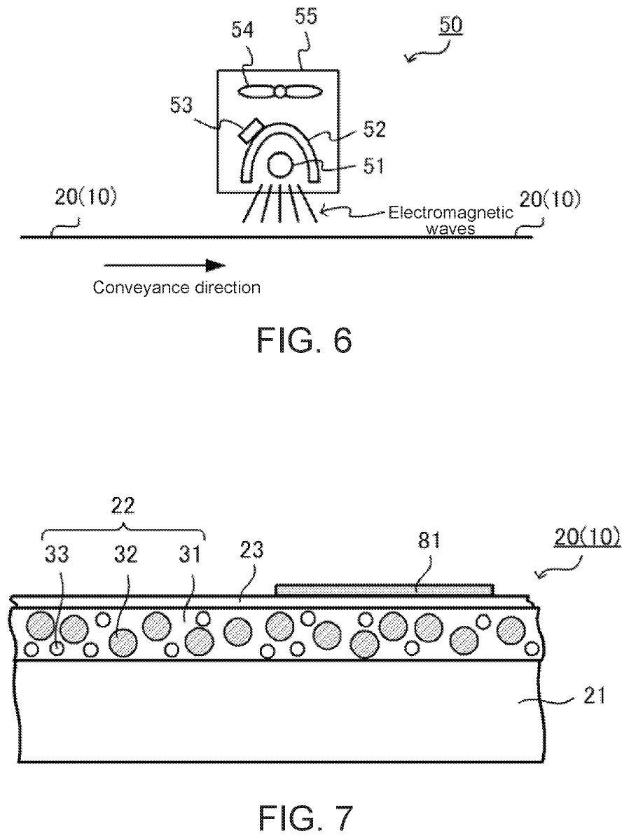

Specifically, as illustrated in FIG. 6, the distension device 50 is provided with, inter alia, an irradiation unit 51 having, for example, a lamp heater, a reflective plate 52 that reflects electromagnetic waves radiated from the irradiation unit 51 toward the coated sheet 20, a temperature sensor 53 that measures the temperature of the reflective plate 52, a cooling unit 54 that cools the inside of the distension device 50, a conveyance roller pair (not illustrated) that grip the coated sheet 20 and convey the coated sheet 20 along a conveyance guide, and a conveyance motor (not illustrated) for rotating the conveyance roller pair. The irradiation unit 51, the reflective plate 52, the temperature sensor 53, and the cooling unit 54 are housed inside a housing 55. The coated sheet 20 is conveyed under the irradiation unit 51 by the conveyance roller pair.

The lamp heater is, for example, provided with a halogen lamp. The lamp heater irradiates the coated sheet 20 with electromagnetic waves (light) in the near-infrared region (wavelength: 750-1400 nm), the visible region (wavelength: 380-750 nm), or the mid-infrared region (wavelength: 1400-4000 nm). The irradiation unit 51 is not limited to a halogen lamp, and other configuration can be adopted therefor provided that electromagnetic waves are able to be radiated thereby. The wavelength of the electromagnetic waves is also not limited to the aforementioned ranges.

The coated sheet 20 on which a thermal conversion layer 81 has been printed illustrated in FIG. 5A is conveyed to the distension device 50 with the front surface thereof facing upward. The distension device 50 irradiates the front surface of the coated sheet 20 with electromagnetic waves using the irradiation unit 51. Electromagnetic waves are more efficiently converted into heat at portions of the coated sheet 20 where the thermal conversion layer 81 has been formed than at portions of the coated sheet 20 not provided with the thermal conversion layer 81. Consequently, it is mainly the portions of the coated sheet 20 where the thermal conversion layer 81 has been formed that are heated, and the thermally distensible material 32 distends once the temperature at which distension begins has been reached. As a result, the thermally distensible material 32 in the distensible region 22a of the coating layer 22 distends as illustrated in FIG. 5B. The feel of the distensible region 22a of the coating layer 22 can thereby be made to differ from the feel of the non-distensible region 22b.

Through such a procedure, it is possible to easily change the feel of at least one region of the coated sheet 20.

In the present embodiment, the coated sheet 20 is provided with a coating layer 22 containing a thermally distensible material 32. By distending the thermally distensible material 32 in at least one region (the distensible region 22a) of the coating layer 22, the feel of the distensible region 22a and the feel of the non-distensible region 22b can be made to differ from one another. In the present embodiment, because feel can be changed by distension of the thermally distensible material 32, a mold or the like is not needed, and feel is able to be easily changed.

Moreover, as in the above embodiment, for example, by providing a thermal conversion layer 81 on one face of a coated sheet 20 and irradiating the thermal conversion layer 81 with electromagnetic waves to heat the thermal conversion layer 81, it is possible to heat a prescribed region of the coating layer 22, and to selectively change the feel of only this region.

The present invention is not limited to the above embodiment, and various modifications thereto and applications thereof are possible.

For example, in the above embodiment, an example is given in which a medium 10 having a coating layer 22 is in the form of a sheet; however, there is no limitation thereto. For example, a coating layer 22 may be provided on a base member 21 that has protrusions and/or recesses on the front surface thereof. The base member 21 is also not limited to the form of a sheet, and may be more thickly formed. In addition, the base member 21 may have a curved surface, and a recessed/protruding shapes may be provided on the front surface of the base member 21. In this case, the procedure to form the coating layer 22 would be modified, as appropriate, according to the shape of the base member 21.

On the medium 10 (coated sheet 20), a color ink layer (not illustrated) may be provided to at least one face of the medium 10 (the front surface or the rear surface illustrated in FIG. 2). The color ink layer is a layer composed of ink that is used in an offset printer, a flexographic printer, or any other such printer. The color ink layer may be formed from any of a water-based ink, an oil-based ink, a UV-curable ink, or the like. The color ink layer is a layer that expresses characters, numerals, photos, patterns, or other imagery. When the color ink layer is formed using a water-based inkjet printer, preferably, an ink-accepting layer (not illustrated) that accepts ink is first provided on the face where the color ink layer will be formed, and then the color ink layer is formed.

The thermal conversion layer 81 may also be formed on the rear side face of the coated sheet 20, or may be formed on the front side and the rear side of the coated sheet 20. The electromagnetic waves are not limited to being irradiated onto the face of the coated sheet 20 where the thermal conversion layer 81 is formed, and may be radiated onto the opposite side of the coated sheet 20 to where the thermal conversion layer 81 is formed.

The thermal conversion layer 81 is not limited to being formed directly on the coated sheet 20. The thermal conversion layer 81 may be provided on the coated sheet 20 with a film or the like interposed therebetween such that the thermal conversion layer 81 is able to be removed by peeling the film off of the coated sheet 20 after distension of the coating layer 22. In this case, as illustrated in FIG. 7, for example, the coated sheet 20 is provided with a film 23 that is provided on the coating layer 22. The film 23 is, for example, composed of a resin selected from a polyester, a polyethylene, a polyvinyl alcohol, a polyethylene terephthalate, or a copolymer thereof. A film composed of an ethylene-vinyl alcohol copolymer can be used for the film 23. The film 23 may also be provided on the rear surface (the lower surface of the base member 21 illustrated in FIG. 7) of the coated sheet 20, or may be provided on the front surface and the rear surface of the coated sheet 20.

The above embodiment was described using an example in which a thermal conversion layer 81 is formed and the thermal conversion layer 81 is irradiated with electromagnetic waves to heat a prescribed region of the coating layer 22. The method of heating a prescribed region of the coating layer 22 is not limited thereto. For example, it is also possible to heat a prescribed region by, inter alia, radiating a lamp thereon with a mask or the like interposed therebetween.

The distension device 50 is not limited to a configuration in which the distension device 50 is provided independently, as illustrated in FIG. 6. For example, the distension device 50 can be used in a shape forming system also provided with a control unit, a printing unit, and a display unit. The control unit is provided with a controller or the like that has a central processing unit (CPU), etc., and the control unit controls the distension device, the printing unit, the display unit, and the like. The printing unit is an inkjet printer or other known printer. The display unit is a liquid-crystal panel, a touch panel, or the like.

In the above embodiment, an example is given in which a procedure to form a thermal conversion layer 81 is performed when feel is to be changed; however, there is no limitation thereto. In a method in which a thermal conversion layer 81 is formed and feel is changed when a sheet 20 is manufactured, configuration may such that only a distension procedure using the distension device 50, etc., is performed. This may also be performed in combination with any procedure from the manufacture of the sheet 20 illustrated in FIGS. 3A and 3B to the changing of feel illustrated in FIGS. 5A and 5B.

Note that although a thermal conversion layer 81 may not always clearly constitute a layer depending on, inter alia, the image to be printed, the printing method, and the printing pattern (dot style), in the present specification, the term “layer” is used to facilitate explanation.

Each of the drawings used in the embodiments are for describing the embodiments. Accordingly, the thicknesses of sheet layers are not intended to be interpreted as limiting the layers to being formed in the ratio illustrated in the drawings. These are also not intended to be interpreted as limiting the proportions of the thermally distensible material 32, the feel-adjusting material 33, etc., contained in the coating layer 22. Furthermore, in the drawings used in the embodiments, the thermal conversion layer 81 and the like provided on the sheet are illustrated in an emphasized manner for the sake of explanation. The thicknesses of the thermal conversion layer 81 and the like are not intended to be interpreted as limiting these elements to being formed in the ratio illustrated in the drawings.

Although a preferred embodiment of the present invention has been described, it should be noted that the present invention is not limited to this specific embodiment, and the accompanying claims and their equivalents are intended to cover all modifications and variations as would fall within the scope and spirit of the present invention.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A medium, comprising:
a base member; and
a coating layer that covers at least a portion of the base member,
wherein the coating layer includes a binder and thermally distensible particles, and
wherein a thickness of the coating layer is smaller than a maximum-distension particle diameter of the thermally distensible particles.

2. The medium according to claim 1, wherein the coating layer further contains a feel-adjusting material.

3. The medium according to claim 2, wherein the feel-adjusting material is an ink-accepting material that accepts ink by taking up ink into a void therein, or by swelling with ink.

4. The medium according to claim 2, wherein the feel-adjusting material is a porous material or a resin material.

5. The medium according to claim 2, wherein the thermally distensible particles make up 20-60%, by weight, of a total weight of the binder, the thermally distensible particles, and the feel-adjusting material.

6. The medium according to claim 2, wherein the feel-adjusting material makes up at least 10%, by weight, of a total weight of the binder, the thermally distensible particles, and the feel-adjusting material.

7. The medium according to claim 1, wherein a pre-distension particle diameter of the thermally distensible particles is 5 μm to 50 μm, a particle diameter of the thermally distensible particles distends a maximum of five times the pre-distension particle diameter, and the thickness of the coating layer is 20 μm to 200 μm.

8. The medium according to claim 1, further including a resin film on the base member or on the coating layer.

9. The medium according to claim 1, further including a resin film on each of the base member and the coating layer.

10. A method of manufacturing a medium, comprising:
preparing a base member; and
forming a coating layer that includes a binder and a thermally distensible particles on the base member so as to cover at least a portion of the base member,
wherein in the forming of the coating layer, a thickness of the coating layer is made smaller than a maximum-distension particle diameter of the thermally distensible particles.

11. The method according to claim 10, wherein the coating layer further contains a feel-adjusting material.

12. The method according to claim 11, wherein the feel-adjusting material is an ink-accepting material that accepts ink by taking up ink into a void therein, or by swelling with ink.

13. The method according to claim 11, wherein the feel-adjusting material is a porous material or a resin material.

14. The method according to claim 10, wherein a pre-distension particle diameter of the thermally distensible particles is 5-50 μm, a particle diameter of the thermally distensible particles distends a maximum of five times the pre-distension particle diameter, and the thickness of the coating layer is 20 μm to 200 μm.

15. A method of changing feel of a medium, comprising:
preparing a medium that includes a base member and a coating layer that covers at least a portion of the base member, the coating layer including a binder and thermally distensible particles, a thickness of the coating layer being smaller than a maximum-distension particle diameter of the thermally distensible particles; and
heating a portion of the coating layer to cause distension of the thermally distensible particles in said portion, thereby creating a distended surface profile in said portion of the coating layer so as to cause a feel of touch by a human to differ on said portion of the medium from on other portions of the medium.

16. The method according to claim 15, wherein the heating of the portion of the coating layer includes:
forming a thermal conversion layer on the coating layer on said portion, the thermal conversion layer includes an electromagnetic wave/heat converting material that converts electromagnetic waves into heat; and
irradiating the thermal conversion layer with the electromagnetic waves so as to heat the said portion of the coating layer.

17. The method of changing feel according to claim 16, wherein the thermal conversion layer is formed on the base member or the coating layer.

18. The method of changing feel according to claim 16, wherein the thermal conversion layer is formed on each of the base member and the coating layer.
